(19) United States
(12) Patent Application Publication
(10) Pub. No.: US 2023/0407813 A1
(43) Pub. Date: Dec. 21, 2023

(54) ASSEMBLY FOR A TURBOMACHINE

(71) Applicant: SAFRAN NACELLES, GONFREVILLE-L'ORCHER (FR)

(72) Inventors: Jean-Philippe JORET, MOISSY-CRAMAYEL (FR); Vincent DEVANLAY, MOISSY-CRAMAYEL (FR); Fabien BRAVIN, MOISSY-CRAMAYEL (FR); Hélène MALOT, MOISSY-CRAMAYEL (FR)

(73) Assignee: SAFRAN NACELLES, GONFREVILLE-L'ORCHER (FR)

(21) Appl. No.: 18/251,860

(22) PCT Filed: Nov. 3, 2021
(86) PCT No.: PCT/FR2021/051937

§ 371 Date: May 4, 2023

(30) Foreign Application Priority Data
Nov. 5, 2020 (FR) 2011382

(51) Int. Cl. F02K 1/04; F02K 1/80

(52) U.S. Cl. CPC F02K 1/04; F02K 1/80

(57) ABSTRACT

An assembly for a turbomachine includes an exhaust cone and an exhaust casing having an annular inner shell. The exhaust cone and the exhaust casing can extend about a first axis, the exhaust cone can have an outer surface extending in the projection of the inner shell, the exhaust cone can be connected to the exhaust casing by means of a flange, the flange having an upstream portion fastened to the exhaust casing and lugs extending downstream from said upstream portion, and the exhaust cone can be fastened to the lugs. The flange can be sectorized and include of a plurality of angular sectors arranged so as to be circumferentially adjacent, with each flange sector having at least one lug extending rectilinearly along a second axis parallel to the first axis.

### TECHNICAL FIELD OF THE INVENTION

The invention relates to an assembly for a turbomachine, in particular an exhaust cone for a turbojet engine or an aircraft turboprop engine.

### PRIOR ART

A propulsion assembly for an aircraft, also known as integrated propulsion system, conventionally includes a turbomachine, for example a turbojet engine, a nacelle and a mast or coupling pylon intended to enable the coupling of the propulsion assembly on a structural portion, for example under the wing, of the aircraft.

The turbomachine is for example a turbofan engine. Such a turbomachine 1, illustrated in FIG. 1, has an axis X and includes from upstream to downstream in the direction of gas flow inside the turbomachine, a fan 2, a low-pressure compressor 3, a high-pressure compressor 4, a combustion chamber 5, a high-pressure turbine 6 and a low-pressure turbine 7.

Hereinafter in the description, the terms upstream and downstream are defined in relation to the direction of gas flow inside the turbomachine.

Moreover, the terms axial, radial and circumferential are defined in relation to the axis X of the turbomachine.

The air F entering at the fan is divided into a primary air flow F1 flowing through a so-called primary path 8 and into a secondary air flow F2 flowing through a so-called secondary path 9, surrounding the primary path 8. The low- and high-pressure compressors 3, 4, the combustion chamber 5 and the high- and low-pressure turbines 6, 7 are located at the primary path 8.

The high-pressure turbine 6 drives the high-pressure compressor 4 via a so-called high-pressure shaft. The low-pressure turbine 7 drives the low-pressure compressor 3 and the fan 2, via a so-called low-pressure shaft and optionally via a reduction gear in the case where the rotational speed of the fan 2 is lower than the rotational speed of the low-pressure compressor 3.

The majority of the thrust generated by the turbomachine 1 is produced by the secondary flow F2, downstream from the fan 2.

The fan 2 is surrounded by a fan case 10, a so-called intermediate case 11 being located downstream from the fan case 10. The intermediate case 11 includes a radially outer shell 12 located in the projection of the fan case 10 and a so-called inter-path portion 13, located between the primary path 8 and secondary path 9. The inter-path portion 13 includes a separating spout 14 at the upstream end thereof and is connected to the outer shell 12 by so-called structural arms 15.

The turbomachine 1 furthermore includes a central case 16, located downstream from the inter-path portion 13 of the intermediate case 11, and an exhaust case 17, located downstream from the central case 16 and on which an exhaust cone 18 is mounted. As seen more clearly in FIG. 2, the exhaust case 17 includes a radially inner shell 19 and a radially outer shell 20, connected by radially extending blades. The inner 19 and outer shells 20 of the exhaust case 17 or motor case define the downstream end of the primary path 8 between them.

As illustrated in FIG. 2, the nacelle 21 of the propulsion assembly conventionally includes a fan nacelle 22, surrounding the fan 2 as well as the fan case 10 and the outer shell 12 of the intermediate case 11. The fan nacelle 22 forms an air inlet lip 23 at the upstream end thereof. The nacelle 21 furthermore includes a motor nacelle 24 surrounding the zones of the turbomachine 1 including the high-pressure compressor 4, the combustion chamber 5, the high-pressure turbine 6, and the low-pressure turbine 7 in particular.

As illustrated in FIG. 3 and known from the document FR 3 084 916 held by the Applicant, the upstream end of the exhaust cone 18 is connected to the downstream end of the inner shell 19 of the exhaust case 17 via an annular connection flange 25 (also seen in FIG. 4). The cone 18 is generally made of ceramic matrix composite material, also known as the acronym CMC. The cone 18 can furthermore include an inner acoustic structure 26. The inner shell 19 of the exhaust case 18 is metallic, for example made of nickel-based alloy, for example of Inconel.

The flange 25 is metallic, for example made of nickel-based alloy (Inconel for example), and includes an annular portion 27 of axis X, from which flexible lugs 28 extend. The lugs 28 are regularly distributed along the circumference.

Such soft or flexible lugs 28 make it possible to compensate for differential expansion phenomena occurring between the inner shell 19 of the exhaust case 17 and the cone 18, these two elements 17, 18 being made of different materials.

Such an annular flange 25 is generally manufactured by machining a large-sized unwrought element, such a manufacture being relatively costly.

### PRESENTATION OF THE INVENTION

The invention aims to remedy this drawback, in a simple, reliable and inexpensive manner. To this end, the invention relates to an assembly for a turbomachine including an exhaust cone and an exhaust case including an annular inner shell, the exhaust cone and the exhaust case extending about an axis, the exhaust cone including an outer surface extending in the projection of said inner shell, the exhaust cone being connected to the exhaust case via a flange, said flange including an upstream portion fastened to the exhaust case and lugs extending downstream from said upstream portion, the exhaust cone being fastened to said lugs, characterized in that the flange is segmented and consists of several angular segments arranged circumferentially adjacent, each flange segment including at least one lug extending in a rectilinear manner along an axis parallel with the axis of the cone.

It is thus possible to produce each flange segment using an element of unwrought material of smaller dimensions than in the case of the prior art, which makes it possible to limit costs and machining times. Such a structure also makes it possible to set up serial production of the flange segments.

The fact that each lug is planar and extends along a rectilinear axis parallel with the axis of the exhaust case and the cone, i.e., parallel with the axis of the turbomachine, makes it possible to limit the mechanical stress in each flange segment, and in particular in the lugs, so as to prevent any premature degradation. Such a structure of the lugs also makes it possible to facilitate the production of the segments and limit the size of each segment.

The lugs can be formed by strips, for example planar. Each lug can have a substantially constant thickness. Each lug can have a rectangular general shape, viewed radially from the outside inward. Each lug can have a rectangular cross-section.

The adjacent segments can be arranged end to end or can be regularly spaced apart in the circumferential direction.

Each lug can be flexible or elastically deformable in the radial direction, so as to compensate for any differential expansion effects between the cone and the exhaust case, when they are made of different materials for example. The thickness of each lug, i.e., the dimension thereof in the radial direction, is for example between 0.5 mm and 10 mm.

The cone is for example made, at least partially, of ceramic matrix composite material, also known as the acronym CMC. The exhaust case is for example made, at least partially, of metallic material capable of withstanding high temperatures during the operation of the turbomachine.

Each flange segment can extend over an angular range less than 180°.

The number of segments distributed along the circumference can thus be between 0 and 200.

Each flange segment can include between 1 and 100 lugs, preferably between 1 and 10 lugs, preferably between 3 and 6 lugs.

The assembly can include means for coupling in rotation and/or positioning each flange segment.

The means for coupling in rotation and/or positioning can include at least one positioning stud formed on the corresponding segment, engaged in a complementary recess or orifice of the exhaust case or the cone, or vice versa.

The positioning stud can extend radially from the upstream portion of each segment and be engaged in a recess or an orifice of complementary shape of the exhaust case. Obviously, the recess or the orifice can be arranged in an element fastened to the exhaust case or to the cone.

The means for coupling in rotation and/or positioning can include at least one flat section formed on the corresponding segment, pressing on an edge or a corresponding planar surface of the exhaust case or the cone, or vice versa.

Obviously, the flat section can press on an edge or a corresponding planar surface of an element fastened to the exhaust case or to the cone.

The means for coupling in rotation are capable of preventing the rotation of the corresponding segment in relation to an axis perpendicular to the axis of the cone and the exhaust case, i.e., in relation to a radial axis.

The flat section can be formed by a projecting zone extending from the upstream portion of the corresponding segment and press on an edge or a corresponding planar zone of the exhaust case or of an element fastened to said exhaust case.

For each segment, the means for coupling rotation and/or positioning can include two flat sections, for example by two projecting zone, separated circumferentially from each other.

The cone can include a radially inner skin and a radially outer skin, defining a chamber between them, the outer skin forming at least partially said outer surface of the exhaust cone.

The chamber can be an acoustic chamber.

The acoustic chamber makes it possible to limit noise pollution caused by the flow of gases from the turbine.

The radially inner skin and the radially outer skin can be connected by at least one radially extending wall.

The radially outer skin can extend axially toward the upstream to the exhaust case, the flange segments being located radially inside the radially outer skin, the lugs being fastened to the radially inner skin.

The upstream end of the outer skin can then be separated by a limited gap in relation to the exhaust case.

An annular seal can extend between the exhaust case and the outer skin, so as to prevent the introduction of leakage air through the aforementioned gap.

The upstream portion of each segment can be fastened onto a radial or axial downstream portion of the exhaust case, directly or via a connecting element.

The connecting element can have an L-shaped cross-section.

The upstream portion of each segment can be fastened to the exhaust case via at least one bolt.

Each lug of each segment can be fastened to the exhaust cone via at least one bolt.

The invention also relates to a turbomachine including at least one assembly of the aforementioned type.

### BRIEF DESCRIPTION OF THE FIGURES

FIG. 1 is a schematic axial sectional view of a turbomachine of the prior art,

FIG. 2 is a schematic axial sectional view of a propulsion assembly of the prior art,

FIG. 3 is an axial sectional half-view of a portion of a turbomachine exhaust assembly of the prior art,

FIG. 4 is a perspective view of a connecting flange between an exhaust cone and an exhaust case, according to the prior art,

FIG. 5 is a sectional view of a portion of an assembly according to the invention,

FIG. 6 is a sectional and perspective view of a portion of an assembly according to the invention,

FIG. 7 is a perspective view of a portion of an assembly according to the invention,

FIG. 8 is a perspective view of a flange segment according to an embodiment of the invention,

FIG. 9 is a perspective view of a flange segment according to another embodiment of the invention,

FIG. 10 is a schematic axial sectional view of a portion of a first embodiment of the assembly according to the invention,

FIG. 11 is a view corresponding to FIG. 10, illustrating a second embodiment of the invention,

FIG. 12 is a view corresponding to FIG. 10, illustrating a third embodiment of the invention,

FIG. 13 is an exploded perspective view, illustrating the case of a segment including a single lug, according to a first embodiment of the invention,

FIG. 14 is a perspective view, illustrating the case of a segment including a single lug, according to a first embodiment of the invention,

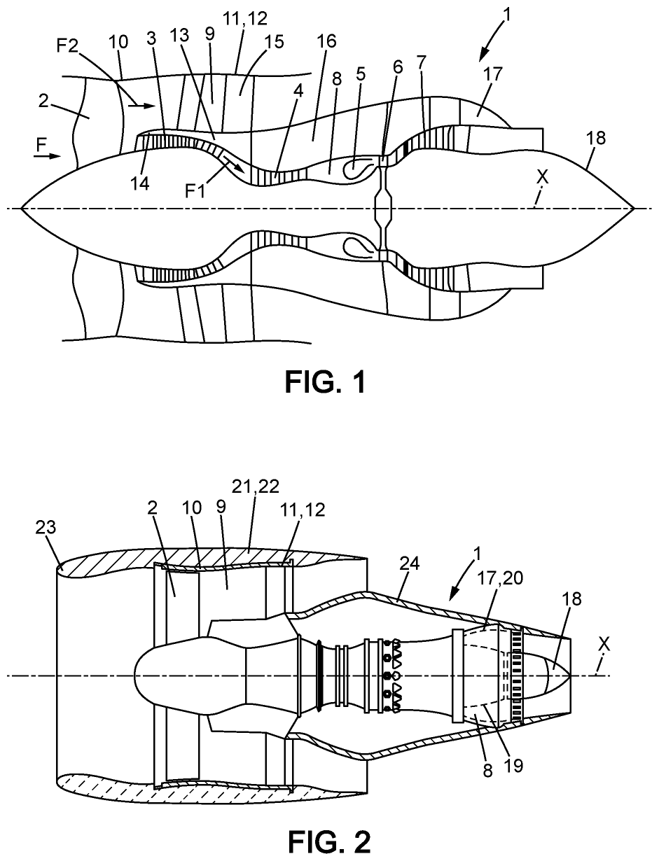

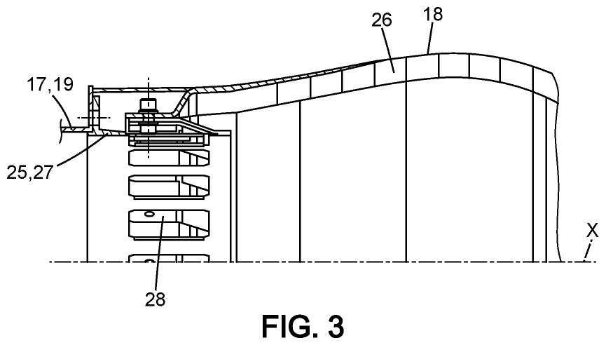

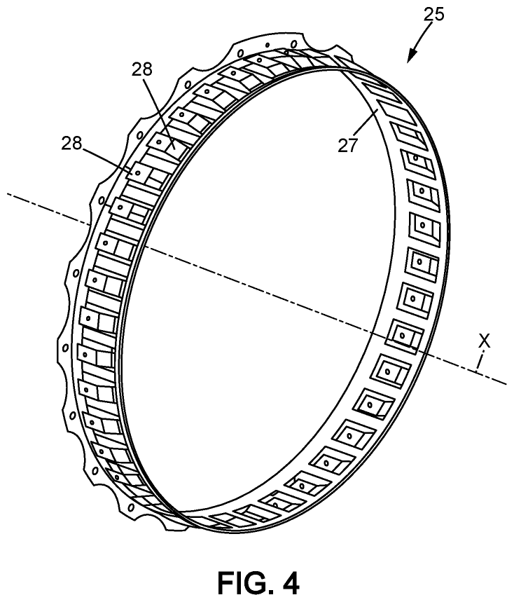

### DETAILED DESCRIPTION OF THE INVENTION

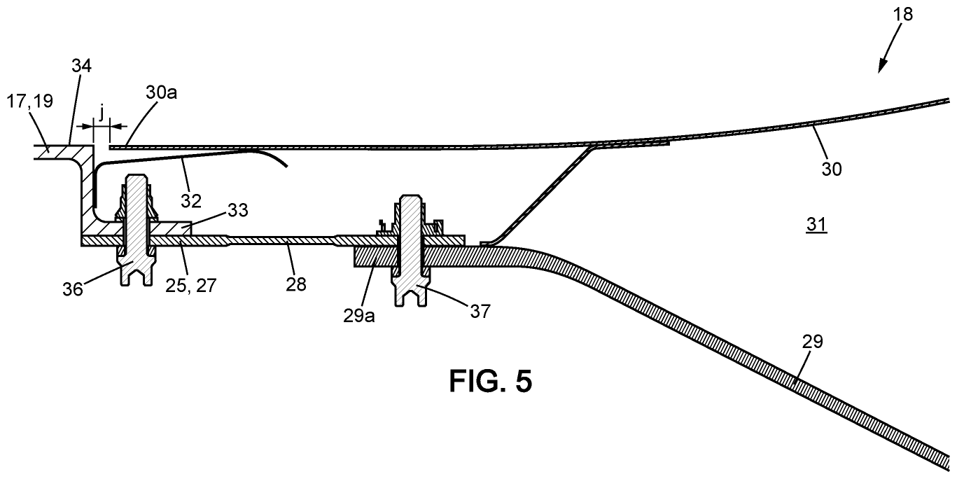

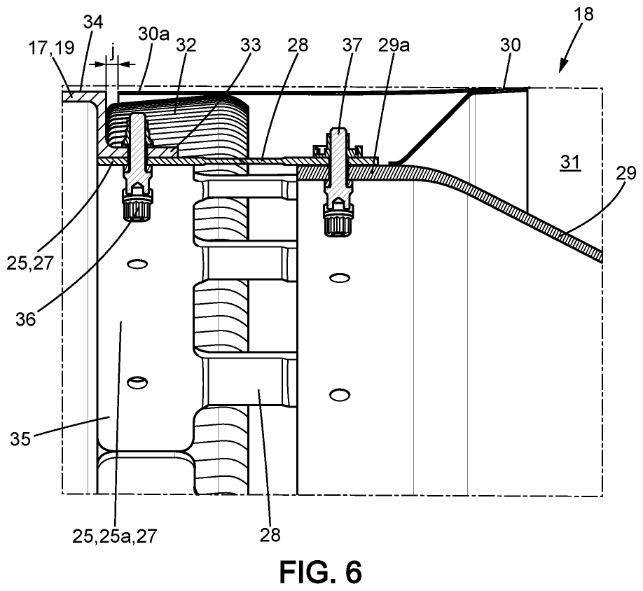

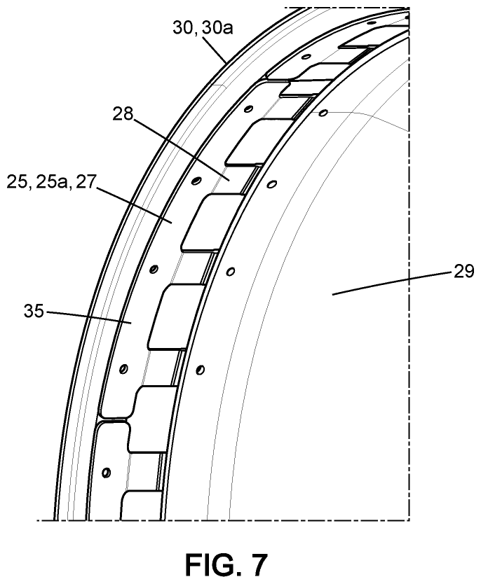

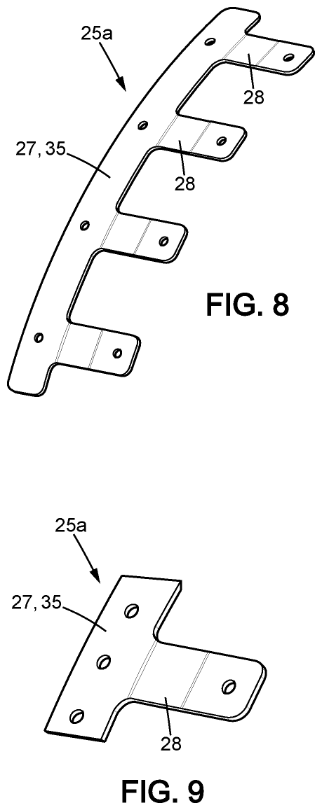

FIGS. 5 to 8 illustrate an exhaust assembly for an aircraft turbomachine 1 according to an embodiment of the invention. This assembly includes an exhaust case 17 including, as above, a radially outer inner annular shell 19 and a radially outer annular shell 20, connected by radial blades. Only the inner shell 19 is illustrated in FIGS. 6 and 7.

The assembly further includes an exhaust cone 18 including a radially inner skin 29 and a radially outer skin 30, defining a chamber, for example an acoustic chamber 31, between them. The radially outer skin 30 is a so-called acoustic skin and extends axially toward the upstream to the inner shell 19 of the exhaust case 17. The upstream end 30a of the outer skin 30 is separated by an axial gap j at least equal to 0.2 mm, for example, in relation to the exhaust case 17.

An annular seal 32 extends between the downstream end of the inner shell 19 of the exhaust case 17 and the outer skin 30, so as to prevent the introduction of leakage air through the aforementioned gap j.

The downstream end of said inner shell 19 includes an axially extending annular rim 33, radially offset inward in relation to the radially outer surface 34 of the inner shell 17 intended to define the primary path 8.

A segmented annular flange 25 connects the annular rim 33 and the upstream end 29a of the inner skin 29 of the exhaust cone 18.

The flange 25 consists of several angular segments 25a arranged circumferentially end to end, each flange segment 25a including an upstream portion 35 extending circumferentially from which one or more planar lugs 28 extend in a rectilinear manner along an axis parallel with the axis X of the cone 18. The lugs 28 are regularly distributed along the circumference of the flange 25.

The upstream portion 35 of each segment 25a is fastened to the rim 33 via fastening means comprising for example one or more bolts 36, here 4 regularly bolts regularly distributed in the circumferential direction and illustrated in some cases schematically by axis lines.

The downstream end of each lug 28 is fastened to the upstream end 29a of the inner skin 29 of the cone 18 via fastening means comprising for example one or more bolts 37, here a single bolt, represented in some cases by axis lines. Obviously, fastening means by rivets or by welding are also possible for fastening the upstream portion 35 or lugs 28 of each segment 25a.

The number of lugs 28 per segment 25a is here equal to 4, each flange 25 including 8 segments.

Each lug 28 has a substantially constant thickness, a rectangular-shaped cross-section and a rectangular general shape, viewed radially from the outside inward.

The lugs 28 are sufficiently soft and flexible to be elastically deformable and make it possible to compensate the differential expansion effects between the cone 18 and the exhaust case 17. Indeed, the exhaust case 17 is for example made of metallic material, for example made of nickel-based alloy, for example of Inconel. The skins 29, 30 of the cone 18 are for example made of ceramic matrix composite material, the material differences giving rise to such differential expansions according to the temperature in operation.

FIG. 9 illustrates an embodiment where each segment 25a includes a single lug 28, the number of segments 25a of the flange 25 then being between 1 and 200. In this embodiment, the upstream portion 35 is fastened to the case 17 via at least two bolts 36. It will be noted that the presence of at least two bolts 36 for fastening the upstream portion 35 makes it possible to lock each segment 25a in rotation in relation to an axis perpendicular to the axis X of the exhaust case 17 and the cone 18, i.e., in relation to an axis or a radial direction.

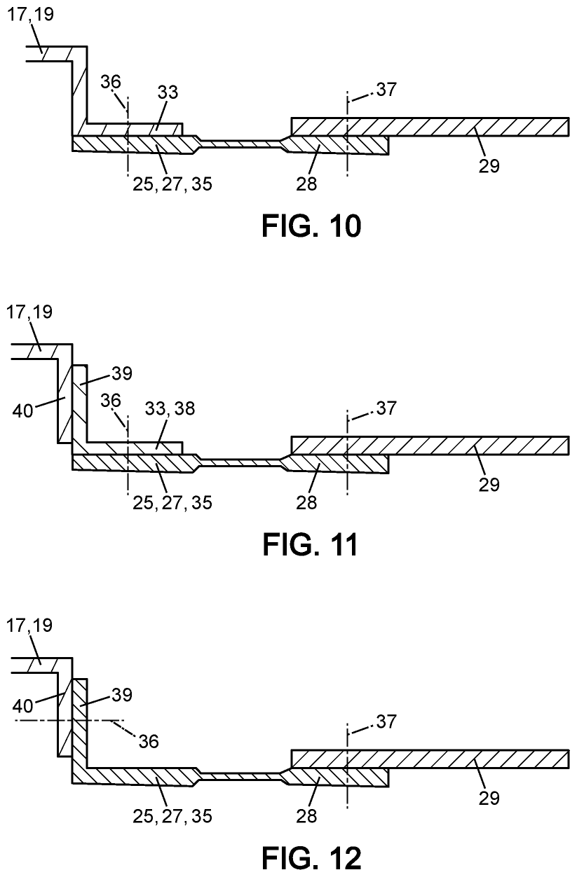

FIG. 10 schematically illustrates the assembly of the flange 25 segments 25a in relation to the inner shell 19 of the case 17, on one hand, and in relation to the inner shell 29 of the cone 18, on the other.

FIG. 11 illustrates another embodiment, where the axial rim 33 is formed by an intermediate connecting element 38. This element 38 includes a radial annular portion 39, fastened by any suitable means to a radial annular portion 40 of the downstream end of the inner shell 19, and an axial or cylindrical annular portion, forming the rim 33 for fastening the upstream portion 35 of each segment 25a.

FIG. 12 further illustrates another embodiment wherein the upstream end 35 of each segment 25a includes a radial rim 39 extending radially outward, fastened to a radial annular portion 40 of the downstream end of the inner shell 19 of the exhaust case 17.

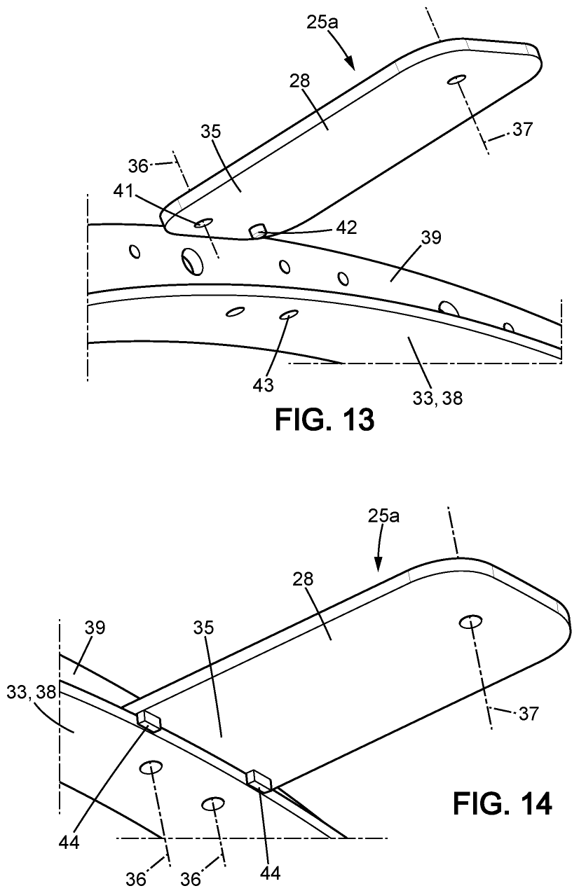

FIGS. 13 and 14 each illustrate an embodiment wherein each segment 25a includes a single lug 28.

In the embodiment in FIG. 13, the upstream portion 35 includes a hole 41 allowing the passage of a fastening means, for example a screw of a bolt 36, and a stud 42 engaged in an orifice or a recess 43 of complementary shape of the rim 33, the fastening means 36 being offset circumferentially from the stud 42. The fastening means 36, the orifice 42 and the recess 43 thus form means for preventing the rotation of the sector 25a in relation to an axis or a radial direction.

In the embodiment of FIG. 14, the upstream portion 35 includes two flat sections formed by studs 44 extending radially inward for example. The studs 44 are separated circumferentially from one another and are pressing on the downstream edge of the axial rim 33. The upstream portion 35 also includes fastening means, formed by one or more bolts 37 for example.

1. An assembly for a turbomachine, comprising:
an exhaust cone; and
an exhaust case including an annular inner shell, the exhaust cone and the exhaust case extending about a first axis, the exhaust cone including an outer surface extending in the projection of the inner shell, the exhaust cone being connected to the exhaust case via a flange, the flange including an upstream portion fastened to the exhaust case and lugs extending downstream from the upstream portion, the exhaust cone being fastened to the lugs,
wherein the flange is segmented and consists of angular segments arranged circumferentially adjacent, each flange segment including at least one lug extending in a rectilinear manner along a second axis parallel with the first axis.

2. The assembly of claim 1, wherein each flange segment extends over an angular range less than 180°.

3. The assembly of claim 1, wherein each flange segment includes 1 to 100 lugs.

4. The assembly of claim 1, further comprising means for rotationally or positionally coupling each flange segment.

5. The assembly of claim 4, wherein the means for rotationally or positionally coupling include at least one positioning stud formed on the corresponding segment and engaged in a complementary recess or orifice of the exhaust case or the cone, or vice versa.

6. The assembly of claim 4, wherein the means for rotationally or positionally coupling include at least one flat section formed on the corresponding segment and pressing on an edge or a corresponding planar surface of the exhaust case or the cone, or vice versa.

7. The assembly of claim 1, wherein the cone includes a radially inner skin and a radially outer skin defining a chamber between them, the outer skin at least partially forming the outer surface of the exhaust cone.

8. The assembly of claim 7, wherein the radially outer skin extends axially toward the upstream to the exhaust case, and wherein the flange segments are located radially inside the radially outer skin and the lugs are fastened to the radially inner skin.

9. The assembly of claim 1, wherein the upstream portion of each segment is fastened onto a radial or axial downstream portion of the exhaust case directly or via a connecting element.

10. A turbomachine including at least one assembly according to claim 1.

11. The assembly of claim 1, wherein each flange segment includes 1 to 10 lugs.

12. The assembly of claim 1, wherein each flange segment includes 3 to 6 lugs.
